(19) United States
(12) Patent Application Publication
(10) Pub. No.: US 2020/0046058 A1
(43) Pub. Date: Feb. 13, 2020

(54) Magnetic Quick-Release Mechanism

(71) Applicant: VICIS, Inc., Seattle, WA (US)

(72) Inventor: Jose Cordero SANTIAGO, Seattle, WA (US)

(21) Appl. No.: 16/656,059

(22) Filed: Oct. 17, 2019

Related U.S. Application Data
(63) Continuation of application No. PCT/US2018/028746, filed on Apr. 21, 2018.
(60) Provisional application No. 62/488,631, filed on Apr. 21, 2017.

(51) Int. Cl. A42B 3/20; F16B 5/06

(52) U.S. Cl. CPC A42B 3/20; F16B 21/12; F16B 5/06

(57) ABSTRACT

A quick-release fastener for attaching helmet components together, such as a facemask or other helmet components to a protective helmet. The quick release fastener comprises a clip and a securing mechanism, which the securing mechanism facilitates quick removal of any component with minimal movement to the player's head and neck via magnetic biasing.

### CROSS-REFERENCE TO RELATED APPLICATIONS

This application is a continuation application of Patent Cooperation Treaty Application Serial No. PCT/US2018/028746, entitled “Magnetic Quick-Release Mechanism,” filed Apr. 21, 2018, which claims the benefit of This application claims the benefit of U.S. Provisional Patent Application Ser. No. 62/488,631 entitled “Magnetic Quick-Release Mechanism,” filed Apr. 21, 2017, the disclosures of which is incorporated by reference herein in its entireties.

### TECHNICAL FIELD

The disclosure relates generally to securing mechanisms, and more specifically to a magnetic quick-release mechanism for securing a facemask and/or other structures to a helmet.

### BACKGROUND

In collision sports, athletes frequently experience physical contact with other players or inanimate objects (such as the ground). In sports such as football, players wear several pieces of protective equipment to mitigate the risk of injury. To protect a player's head from injury upon collision, helmets are specially designed to dampen forces from any impact. Typically, a helmet encloses the top, back, and sides of the player's head while the front of the helmet is open to provide an unobstructed line of sight for the player. To protect the player's face, the helmet includes a facemask that may be removeably secured to the helmet. Current methods for securing the facemask to the helmet generally use standard threaded hardware, which require the use of a tool, such as a screwdriver, and a certain amount of time to fully engage or disengage the threaded mating surfaces. In the event of a medical emergency, quick removal of the facemask with minimal movement to the player's head and neck is critical. As such, a securing mechanism that allows the facemask to be quickly and conveniently secured or removed is needed.

### BRIEF DESCRIPTION OF THE DRAWINGS

The foregoing and other objects, aspects, uses, features, and advantages of embodiments will become more apparent and may be better understood by referring to the following detailed description of the preferred embodiments, taken in conjunction with the accompanying drawings, wherein:

FIG. 1 illustrates a perspective view of a helmet including a securing mechanism according to an embodiment;

FIGS. 2A and 2B illustrate a perspective view and a side view of a mask clip and a securing mechanism, according to an embodiment;

FIG. 3A illustrates a side view of a fastener of the securing mechanism, according to an embodiment;

FIG. 3B illustrates a top view of the mask clip, according to an embodiment;

FIG. 4 illustrates a cross-sectional view of the fastener of the securing mechanism, according to an embodiment;

FIG. 5 illustrates a cross-sectional view of the mask clip and the securing mechanism, according to an embodiment;

FIG. 6 illustrates a first method for removing the fastener from the base and the mask clip, according to an embodiment;

FIGS. 7A, 7B, and 7C illustrate a second method for removing the fastener from the base and the mask clip, according to an embodiment;

FIGS. 8A and 8B depict perspective views of one alternative embodiment of a releasable fastener and clip;

FIG. 8C depicts and exploded view of the releasable fastener and clip of FIG. 8A;

FIGS. 9A and 9B depict perspective views of the mask clip of FIG. 8A;

FIG. 10 depict a perspective view of the fastener of FIG. 8A;

FIG. 11A depicts perspective view of another alternative embodiment of a releasable fastener and clip; and

FIG. 11B depicts a cross-sectional view of the releasable fastener and clip of FIG. 11A.

The above figures depict embodiments of the present disclosure for purposes of illustration only.

### DETAILED DESCRIPTION

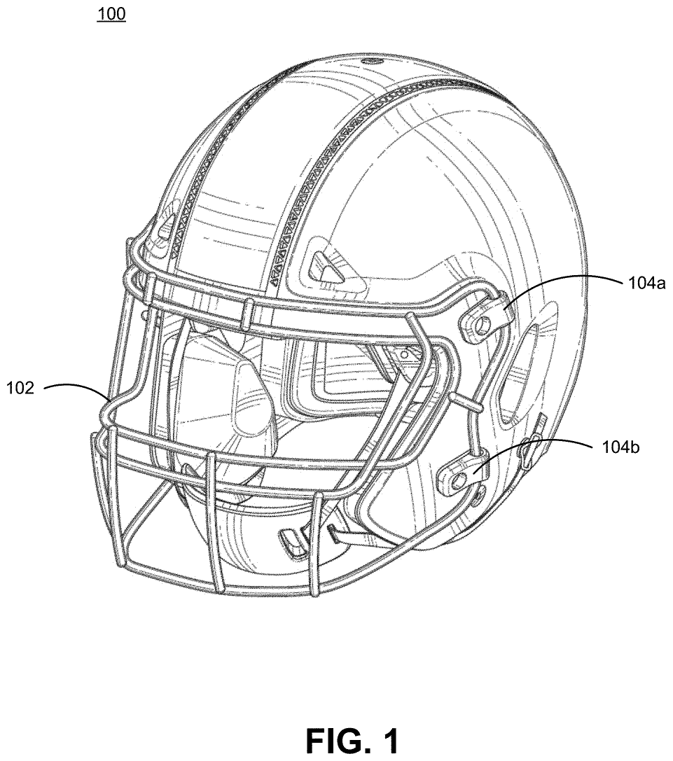

FIG. 1 is a perspective view of a football helmet 100 including a securing mechanism according to an exemplary embodiment. In the embodiment of FIG. 1, a football helmet 100 includes a facemask 102 secured via one or more mask clips 104a and 104b. The football helmet 100 is desirably designed to protect a football player's head from injury upon impact. For this purpose, the helmet 100 encloses the top, back, and sides of the player's head and may have specially designed liners and/or padding within the helmet to dampen forces from any impact. The front of the helmet 100 is desirably open to provide an unobstructed line of sight for the player.

To protect the player's face, the helmet 100 includes the facemask 102. In the embodiment of FIG. 1, the facemask 102 is a wireform enclosure that includes a reinforced structure along the lower half to protect the face and chin. The facemask 102 comprises rigid materials, such as steel or other hard metals (typically with a plastic or rubber over coating), although other embodiments of facemasks could comprise semi-rigid and/or flexible materials. The configuration of the facemask 102 may be tailored for certain positions that may experience more or less collisions or certain types of collisions.

In the embodiment of FIG. 1, one or more mask clips 104a and 104b removeably secure the facemask 102 to the helmet 100. As shown in FIG. 1, a plurality of mask clips 104a and 104b are positioned around the perimeter of the opening on the front side of the helmet 100, and each mask clip 104a and 104b is secured to the football helmet 100 with a respective securing mechanism. Each mask clip 104a and 104b receives a portion of the facemask 102 to properly align and secure the facemask 102 across the opening of the helmet 100.

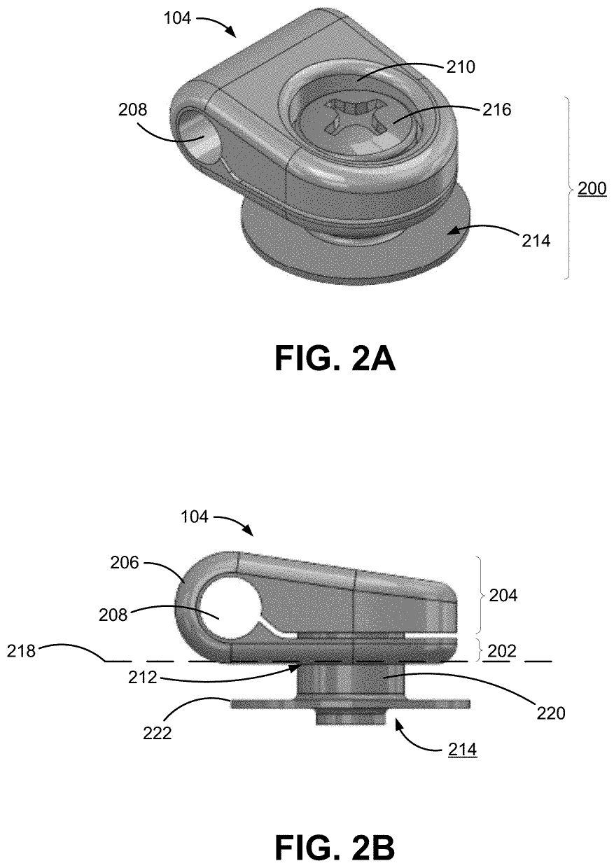

FIGS. 2A and 2B illustrate a perspective view and a side view, respectively, of a mask clip 104 and a securing mechanism 200, according to an exemplary embodiment. Each mask clip 104 can have a respective securing mechanism 200, that secures a portion of the facemask 102 within the mask clip 104 and secures the mask clip 104 to the helmet 100. In the embodiment of FIGS. 2A and 2B, the mask clip 104 includes a lower portion 202, an upper portion 204, a curved portion 206, a facemask passage 208, a fastener passage 210, and a base passage 212. The securing mechanism 200 desirably includes a base 214 and a fastener 216.

The lower portion 202 desirably abuts an outer surface 218 of the helmet 100, represented by a dashed line in FIG. 2B. The lower portion 202 can be flexibly connected to the upper portion 204 via the curved portion 206. The curved portion of the mask clip 104 is desirably capable of flexing, which allows the upper portion 204 to rotate towards and away from the lower portion 202. In this configuration, the mask clip 104 can transition between an open state and a closed state. Illustrated in FIGS. 2A and 2B is the mask clip 104 in the closed state, wherein the upper portion 204 lies substantially above the lower portion 202. In the open state (not shown), the upper portion 204 can be rotated away from the lower portion 202. The curved portion 206 may have a wide variety of geometries and/or hinging arrangements that could allow the mask clip 104 to flex open and closed, as desired.

In the embodiment of FIGS. 2A and 2B, the mask clip 104 includes a facemask passage 208 that receives a portion of the facemask 102. As shown in FIGS. 2A and 2B, the facemask passage 208 can be a substantially cylindrical passage that is defined by the curved portion 206, the lower portion 202, and the upper portion 204 of the mask clip 104. In some embodiments, the facemask passage 208 may be co-axially aligned with the curved portion 206 of the facemask. A portion of the facemask 102 can be placed within the facemask passage 208 when the mask clip 104 is in the open state and the upper portion 204 is rotated away from the lower portion 202. Once the facemask 102 is positioned within the facemask passage 208, the upper portion 204 may be rotated towards the lower portion 202 such that the mask clip 104 is in the closed state, thereby enclosing the facemask 102 and positioning it for securing to the helmet 100. It should be understood that the passage 208 could be designed and/or manufactured in a variety of different forms and/or orientations to accommodate structures other than facemasks, as well as to accommodate various other facemask component designs, if desired, including the use of non-circular and/or non-cylindrical shapes (i.e., oval, triangular and/or square as well as keyed and/or splined shapes).

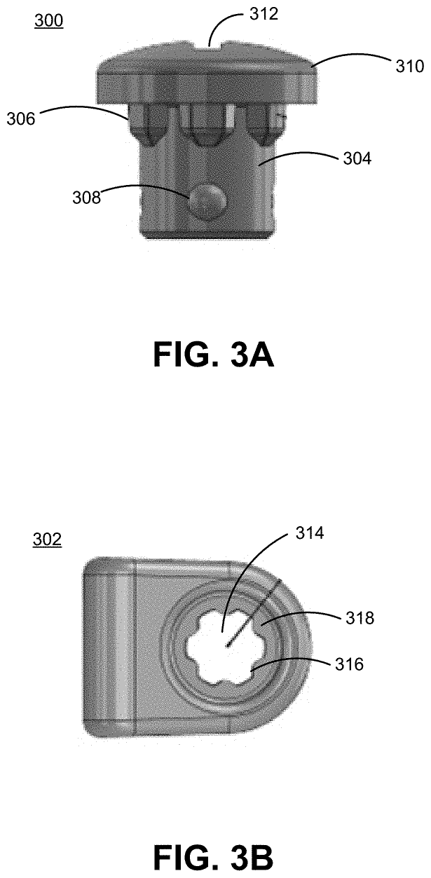

The mask clip 104 further includes the fastener passage 210 and the base passage 212. In the embodiment of FIGS. 2A and 2B, the fastener passage 210 can be a cylindrical opening through the body of the upper portion 204. The fastener passage 210 receives the fastener 216 of the securing mechanism 200 and may further include a ridge 318 (see FIG. 3B) or other alignment or key-type feature that engages with and/or abuts a portion of the fastener 216. The base passage 212 can be a cylindrical opening through the body of the lower portion 202 that is co-axially aligned with the fastener passage 210. An axis of the base passage 212 may be perpendicular to an axis of the facemask passage 208. The base passage 212 receives the base 214 of the securing mechanism 200. In the embodiment of FIGS. 2A and 2B, the base passage 212 may be dimensioned for an interference fit with the base 214 such that the base 214 is secured within the base passage 212 upon insertion. In some embodiments, the fastener 216 and the base 220 may have a variety of geometries other than cylindrical (including geometries such as oval shapes, triangular, square, pentagonal, hexagonal, etc.) wherein the fastener passage 210 and the base passage 212 could typically have complementary geometries.

The securing mechanism 200 can include the base 214 which secures the mask clip 104 to the helmet 100. In the embodiment of FIGS. 2A and 2B, the base 214 includes a generally cylindrical body 220 and a flange 222. A portion of the cylindrical body 220 is inserted into the base passage 212 of the mask clip 104 while the remaining portion of the cylindrical body 220 passes through an opening of the helmet 100. The opening of the helmet 100 is desirably dimensioned such that the flange 222 does not pass through the opening. The flange 222 desirably abuts an inner surface of the helmet 100. In some embodiments, to attach the mask clip 104 to the helmet 100, the cylindrical body 220 of the base 214 may be passed through the opening of the helmet 100 until the flange 222 abuts the inner surface of the helmet 100; the mask clip 104 may then be press fit onto the portion of the cylindrical body 220 that protrudes from the outer surface of the helmet 100 until the lower portion 202 abuts the outer surface of the helmet 100. The base 214 desirably receives and retains a portion of the fastener 216 and thereby prevents the removal of the fastener 216 upon insertion, which will be discussed in greater detail below with regards to FIGS. 3-7.

The securing mechanism 200 further includes the fastener 216. In the embodiment of FIGS. 2A and 2B, the fastener 216 is insertable into the fastener passage 210 of the upper portion 214. As previously mentioned, a portion of the fastener 216 is inserted into the base 214, which will be discussed in greater detail with regards to FIGS. 3-7. Once inserted into the base 214, the fastener 216 desirably secures the mask clip 104 in the closed state, thereby securing the facemask 102 enclosed within the mask clip 104 to the helmet 100.

FIG. 3A illustrates a side view of one embodiment of a fastener 300 of the securing mechanism, and FIG. 3B illustrates a top view of the mask clip 302, according to an embodiment. As described with regards to FIGS. 2A and 2B, the securing mechanism desirably secures the mask clip 302 in the closed state. In other embodiments, the securing mechanism may connect a variety of two or more objects together (which may include individual helmet components) for which it is desirable to assemble and remove the two or more objects in a quick, convenient way. In the embodiment of FIG. 3A, the fastener 300 has a cylindrical body 304 with one or more spline keys 306 and one or more solid bodies 308. The fastener 300 further includes a flange cap 310 with a driving surface 312. In the embodiment of FIG. 3B, the mask clip 302 includes a fastener passage 314, an optional spline interface 316, and a ridge 318. The fastener 300 may be an embodiment of the fastener 216, and the mask clip 302 may be an embodiment of the mask clip 104.

The cylindrical body 304 desirably secures within the base of the securing mechanism. In the embodiment of FIG. 3A, the cylindrical body 304 is generally cylindrical in shape, which allows it to be inserted into the base of the securing mechanism at virtually any rotational orientation. In other embodiments, the cylindrical body 304 may have a variety of shapes and cross-sectional profiles (e.g., conical, rectangular, square, or other regular or irregular polygons). In some embodiments, the cross-sectional profile of the cylindrical body 304 may be constant or varied along the height of the cylindrical body 304. The cylindrical body 304 may be composed of rigid materials, such as metal or hard plastic. At a distal end of the cylindrical body 304, the cylindrical body 304 desirably includes a plurality of openings that house one or more solid bodies 308.

The cylindrical body 304 can optionally include one or more spline keys 306 protruding from the outer surface of the cylindrical body 304. In the embodiment of FIG. 3A, the spline keys 306 are positioned at a proximal end of the cylindrical body 304 near the flange cap 310. In other embodiments, the spline keys 306 may be positioned along the length of the cylindrical body 304. The spline keys 306 are structured to desirably mate with a respective spline interface 316 on the mask clip 302. In the embodiment of FIGS. 3A and 3B, each spline key 306 is positioned at a regular interval along the outer surface of the cylindrical body 304. The regularly-spaced spline keys 306 allow the fastener 300 to be inserted into the fastener passage 314 at a plurality of rotational orientations. In other embodiments, the shape and arrangement of the spline keys may vary.

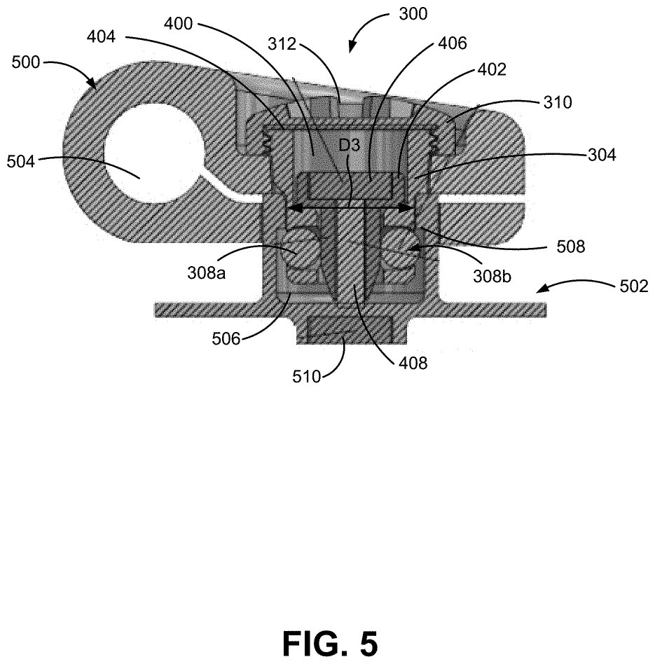

The fastener 300 further includes one or more solid bodies 308. In the embodiment of FIG. 3A, the fastener 300 has four solid bodies 308 that each fit into a respective opening at a distal end of the cylindrical body 304. Each solid body 308 is capable of moving within the fastener 300 such that the solid body 308 is either retracted into the fastener 300 or protrudes outward from the outer surface of the cylindrical body 304. When the solid bodies 308 protrude outwards from the outer surface of the cylindrical body 304, each solid body 308 is capable of mating with an inner ring 508 (see FIG. 5) within the base 502 (see FIG. 5) of the securing mechanism to prevent the removal of the fastener 300 from the base 502. In some embodiments, the number and/or distribution of solid bodies 308 may vary, and the shape of the solid bodies 308 may be spherical, elliptical, wedge-shaped, or any similar configuration. The shape of the openings of the cylindrical body 304 desirably complement the shape of the solid bodies 308 to allow the solid bodies 308 to protrude without falling out of the fastener 300, which in some embodiments may include an opening diameter that is less than an outer diameter of a respective solid body.

In the embodiment of FIGS. 3A and 3B, the flange cap 310 can be removeably secured to a proximal end of the cylindrical body 304. The flange cap 310 may have a threaded portion that mates with a reciprocal threaded portion on the cylindrical body 304. To remove the flange cap 310, a tool may engage the driving surface 312 to rotate the flange cap 310 and disengage the threaded portions. The flange cap 310 can comprise rigid or semi-rigid materials, such as metals or hard plastics. In some embodiments, the flange cap 310 may be shaped and positioned uniform with the cylindrical body 304.

The mask clip 302 includes the fastener passage 314, which receives the cylindrical body 304 of the fastener 300 when the fastener 300 is inserted into the mask clip 302. In the embodiment of FIGS. 3A and 3B, a surface of the fastener passage 314 has a spline interface 316. The spline interface 316 can desirably have a reciprocal shape to the spline keys 306 such that when the fastener 300 is inserted, the spline interface 316 and the spline keys 306 interlock. The configuration of the spline keys 306 and the spline interface 316 in this embodiment desirably prevent rotation of the cylindrical body 304 relative to the mask clip 302. By preventing rotation, the flange cap 310 can be rotated relative to the cylindrical body 304 and removed from the fastener 300. The mask clip 302 further includes a ridge 318 that abuts a bottom surface of the flange cap 310 when the fastener 300 is inserted. In some embodiments, the spline interface 316 may be positioned on a surface within the fastener passage 314 or on the ridge 318.

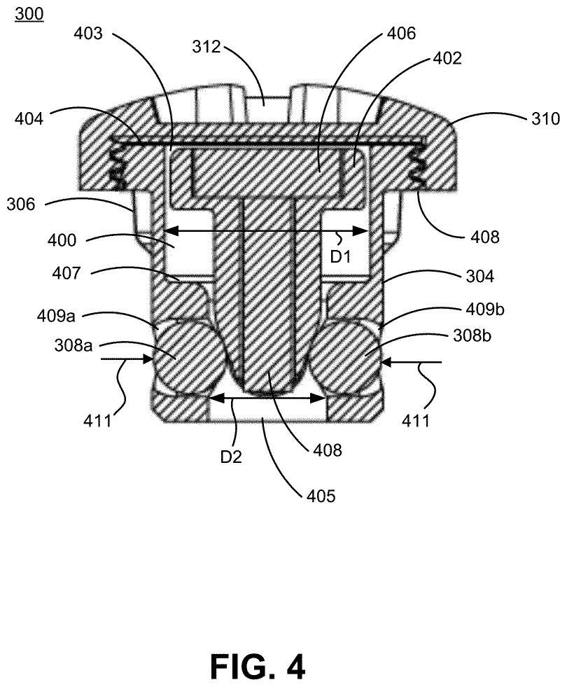

FIG. 4 illustrates a cross-sectional view of the fastener 300 of the securing mechanism in an unlocked state, according to an embodiment. The cross-sectional view shown in FIG. 4 illustrates several internal components that desirably allow for a quick and convenient tool-free assembly of the fastener 300 and the base of the securing mechanism. The fastener 300 further includes an internal passage 400 and a core pin 402. The flange cap 310 further includes a magnetic component 404. FIG. 4 additionally shows the engaged threaded portions 408 between a proximal end of the cylindrical body 304 and the flange cap 310, as discussed above with regards to FIG. 3. Some embodiments of the securing mechanism may have functions distributed among the components in a different manner than is described here. For example, some of the actuation components of the securing mechanism may be embedded within the base of the securing mechanism rather than in the fastener 300, or vice versa.

In this embodiment, the internal passage 400 houses the core pin 402. The cylindrical body 304 has a first opening 403 at the proximal end and a second opening 405 at the distal end between which the internal passage 400 spans. Some embodiments of the fastener 300 may have the first opening 403 and not the second opening 405, while in other embodiments the second opening 405 may be sealed with a plug or other component such as epoxy (i.e., to prevent water, dirt and/or debris from entering the fastener and corroding or otherwise preventing the locking mechanism from operating properly). As shown in FIG. 4, the internal passage 400 may be composed of two sections having different inner diameters, wherein the diameter D1 of the first section accommodates a head of the core pin 402 while the diameter D2 of the second section accommodates the body of the core pin 402. The difference in diameters between the first and second sections of the internal passage 400 may create a ledge 407 within the internal passage 400 that limits the movement of the core pin 402 within the internal passage 400. As shown in FIG. 4, the solid bodies 308a,308b are positioned within respective openings 409a, 409b of the cylindrical body 304. In the embodiment of FIG. 4, the openings 409a, 409b are passages through the wall of the cylindrical body 304. The openings 409a, 409b have an inner diameter to accommodate the size of the solid bodies 308 while the diameter of the openings 409a, 409b decreases at the outer surface of the cylindrical body 304 to allow the solid bodies 308 to protrude without falling out. In this configuration, each solid body 308 communicates between the internal passage 400 and the outer surface of the cylindrical body 304. In some embodiments, the relative size of the inner diameters of the internal passage may be switched, as well as the corresponding geometry of the core pin 402. In other embodiments, the inner diameter of the internal passage may be uniform throughout.

The core pin 402 is a pin-shaped component housed within the internal passage 400 of the fastener 300. As shown in FIG. 4, the core pin 402 has a head and an elongated body with a tapered tip, and the tapered tip of the core pin 402 abuts the solid bodies 308a, 308b. In the embodiment of FIG. 4, the core pin 402 includes a first magnetic component 406 and a second magnetic component 408 that actuate the movement of the core pin 402 within the internal passage 400. The magnetic component 406 is positioned within the head of the core pin 402, and the magnetic component 408 is positioned within the elongated body of the core pin 402. The magnetic components 406, 408 may be composed of magnetic materials (e.g., iron, ferritic steel, etc.) or may be a magnet itself. The attraction of the magnetic components 406, 408 to other magnetic components of the securing mechanism can desirably cause the core pin 402 to translate within the internal passage 400 to actuate the securing mechanism. In some embodiments, the magnetic components 406, 408 may repulse other magnetic components to actuate movement of the core pin 402. In additional embodiments, the fastener 300 may include spring components that supplement the functionality of the magnetic components. In some embodiments, the geometry or orientation of the core pin 402 may also vary. In additional embodiments, the core pin 402 may include a single magnetic component that performs the functionality of the magnetic components 406, 408. For example, the material of the core pin 402 itself may act as the magnetic component.

The flange cap 310 can include a magnetic component 404 which attracts the magnetic component 406 of the core pin 402. In the embodiment of FIG. 4, the magnetic component 404 is a plate embedded within an inner surface of the flange cap 310. The magnetic component 404 may be composed of magnetic materials (e.g., iron, ferritic steel, etc.) or may be a magnet itself. In some embodiments, the flange cap 310 may be composed of magnetic materials (e.g., iron, ferritic steel, etc.) or may be a magnet itself, thus not requiring an additional magnetic component 404. As shown in FIG. 4, the core pin 402 may abut the flange cap 310 due to the magnetic component 404 of the flange cap 310 attracting the magnetic component 406 of the core pin 402. In this configuration, the core pin 402 can be in an unlocked state. In the unlocked state, the tapered tip of the core pin 402 desirably allows the solid bodies 308a, 308b to retract inwards towards the core pin 402, as shown by arrows 411, such that the solid bodies 308, 308b do not protrude from the outer surface of the cylindrical body 304. The unlocked state of the core pin 402 thereby allows the fastener 300 to be easily inserted into the base 502 of the securing mechanism or to be removed from the base 502 of the securing mechanism (see FIG. 5).

FIG. 5 illustrates a cross-sectional view of a mask clip 500 and the securing mechanism in a locked state, according to an embodiment. As illustrated in FIG. 5, the mask clip 500 is secured to a base 502, and the fastener 300 has been inserted into the base 502, thereby securing the mask clip 500 in the closed state and a facemask (not shown) secured within the facemask passage 504. The mask clip 500 may be an embodiment of mask clip 104. In the embodiment of FIG. 5, the base 502 includes a receiving passage 506, an inner ring 508, and a magnetic component 510. Some embodiments of the securing mechanism may have functions distributed among the components in a different manner than is described here. For example, some of the actuation components of the securing mechanism may be embedded within the fastener 300 of the securing mechanism rather than in the base 502, or vice versa.

The receiving passage 506 of the base 502 receives a portion of the fastener 310. In the embodiment of FIG. 5, the receiving passage 506 is substantially cylindrical with an opening on a proximal end and closed at a distal end. The inner diameter D3 of the opening of the receiving passage 506 can be dimensioned for receiving the distal end of the cylindrical body 304. A portion of the receiving passage 506 may have a greater inner diameter than that of the opening, creating the inner ring 508 at the proximal end of the receiving passage 506. Located beneath the receiving passage 506 at the distal end is the magnetic component 510. The magnetic component 510 may be composed of magnetic materials (e.g., iron, ferritic steel, etc.) or may be a magnet itself. In the embodiment of FIG. 5, the magnetic component 510 attracts the magnetic component 408 of the core pin 402. In some embodiments, the receiving passage 506 may have a variety of shapes (e.g., conical, rectangular, square, etc.) to complement the shape of the cylindrical body 304.

As previously described above with regards to FIG. 4, the core pin 402 can move within the internal passage 400. In the unlocked state, the core pin 402 abuts the flange cap 310 due to the attraction between the plate 404 and the magnetic component 406. In the embodiment of FIG. 5, the magnetic component 408 of the base 502 desirably has a stronger attraction force than the plate 404 of the flange cap 310. As a result, when the fastener 300 is inserted into the fastener passage of the mask clip 500 and the receiving passage 406 of the base 502, the attraction between the plate 404 and the magnetic component 406 will desirably be overcome by the attraction between the magnetic component 408 of the core pin 402 and the magnetic component 510 of the base 502. Thus, the core pin 402 moves within the internal passage 400 towards magnetic component 510 of the base 502. In this state, as illustrated in FIG. 5, the core pin 402 contacts the solid bodies 308 and pushes and/or locks the solid bodies 308 to protrude outwards from the outer surface of the cylindrical body 304. The solid bodies 308 protrude such that the effective diameter of the cylindrical body 304 increases and becomes greater than the inner diameter of the inner ring 508 at the opening of the receiving passage 506. The engagement between the solid bodies 308 and the inner ring 508 desirably prevents and/or inhibits the removal of the fastener 300 from the base 502. In this configuration, the core pin 402 is in a locked state, and the fastener 300 is secured within the base 502. In some embodiments, the magnetic component 404, 406, 408, 510 may repulse other magnetic components to actuate movement of the core pin 402.

### Fastener Removal

As previously described, the ability to quickly and conveniently remove a facemask from a player's helmet with minimal movement to the player's head and neck is desired and may be critical in the event of a medical emergency. The securing mechanism described with respect to FIGS. 1-5 facilitates multiple different methods for removing the fastener from the base, allowing the facemask clip to open and the facemask to be removed. In a first method, a magnetic tool may be used to attract the core pin into the unlocked state and allow removal of the fastener. In a second method, a tool (e.g., screwdriver) may be used remove the flange cap from the fastener and allow removal of the core pin from the fastener. The second method may be used in the event that a magnetic tool is not available. In some embodiments of the securing mechanism, the fastener may be configured to be removed from the base via the first method, the second method, or both the first and second methods. In a third method, the fastener design may also allow removal of the facemask from the helmet by cutting and/or fracturing one or more of the lower portion 202, the upper portion 204 and/or the curved portion 206 of the fastener to release the facemask, which can be accomplished with wire cutters or a specialized facemask shear clipper typically available to on-field medical personnel.

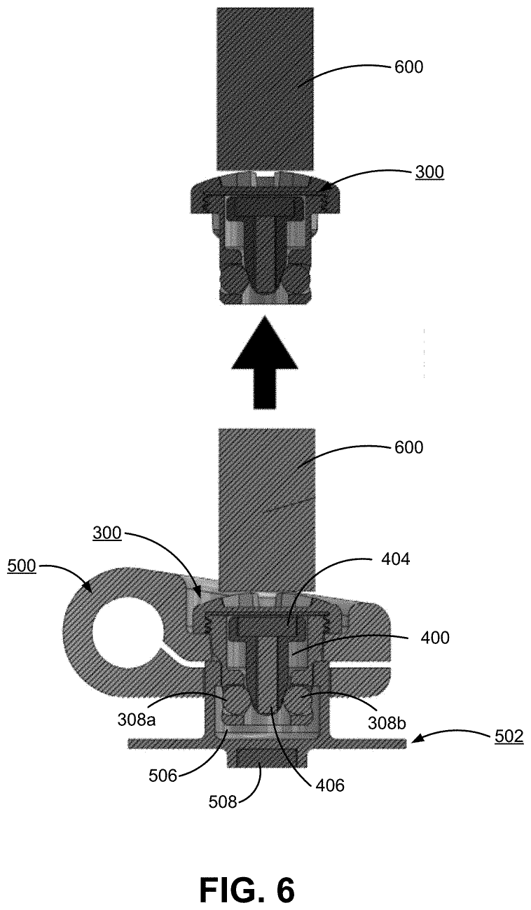

FIG. 6 illustrates a first method for removing the fastener 300 from the base 502 and the mask clip 500, according to an embodiment. In the embodiment of FIG. 6, the fastener 300 may be removed using a magnetic tool 600 that has a stronger attraction force than the magnetic component 508 of the base 502. Aligning the magnetic tool 600 with the fastener 300, as illustrated in FIG. 6, desirably attracts the magnetic component 404 of the core pin 402, wherein the level of attraction overcomes the attraction between the magnetic component 406 of the core pin 402 and the magnetic component 508 of the base 502. As a result, the core pin 402 desirably moves within the internal passage 400 towards the magnetic key 600 and into the unlocked state. With the core pin 402 in the unlocked state, the solid bodies 308 can be retracted inwards into the fastener 300, thus allowing the fastener 300 to be removed from the base 502 and the mask clip 500. This configuration of the securing mechanism desirably allows a facemask or other helmet component to be removed from the mask clip 500 without needing to disengage threaded hardware.

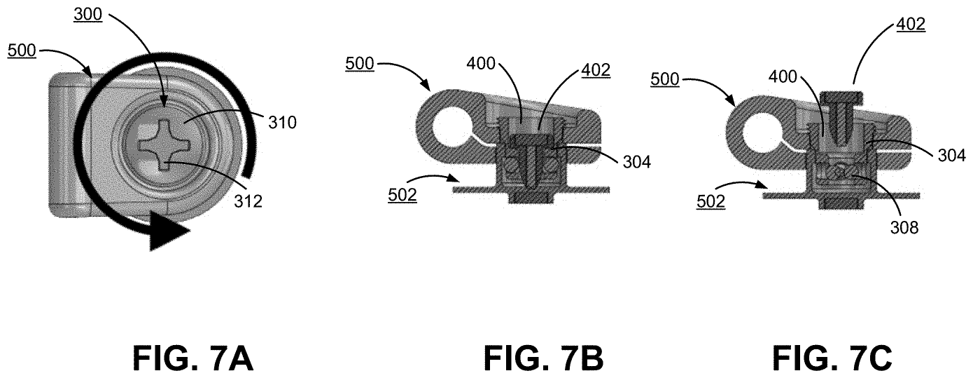

FIGS. 7A, 7B, and 7C illustrate a second method for removing the fastener 300 from the base 502 and the mask clip 500, according to an embodiment. As previously described, in some embodiments, the flange cap 310 may be removeably secured to the cylindrical body 304 of the fastener 300. In the embodiment of FIGS. 7A, 7B, and 7C, the flange cap 310 is threaded onto a proximal end of the cylindrical body 304. The flange cap 310 may be manually removed using a tool that engages with the driving surface 312 and rotates the flange cap 310 until the threaded portions of the fastener are disengaged. FIG. 7B illustrates the fastener with the flange cap 310 removed. Once the flange cap 310 is removed, the core pin 402 may be extracted from the cylindrical body 304, as shown in FIG. 7C. Removing the core pin 402 allows the solid bodies 308 to retract inwards into the cylindrical body 304, thereby allowing the cylindrical body 304 to be extracted from the fastener passage of the mask clip 500.

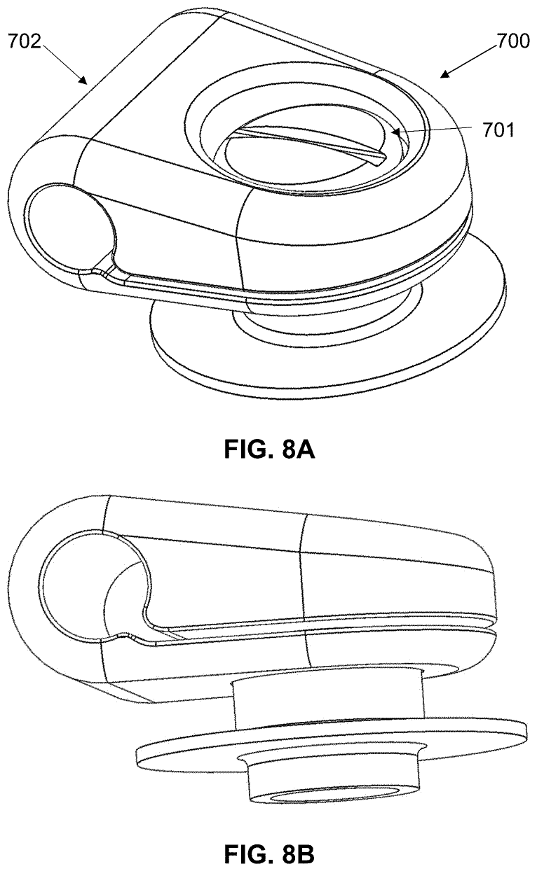

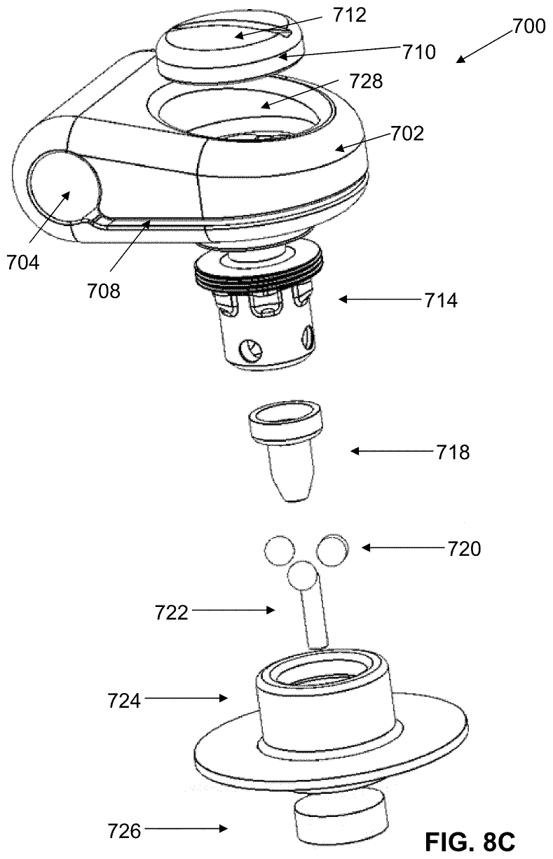

FIGS. 8A and 8B depict perspective views of one alternative embodiment of a mask clip 700 and a releasable securing mechanism 701, according to an exemplary embodiment. Each mask clip 700 can have a clip 702 and a respective securing mechanism 701, that secures a portion of the facemask 102 within the mask clip 700 and secures the mask clip 700 to the helmet 100. In the embodiment of FIGS. 8A and 8B, the clip 702 includes a lower portion, an upper portion, a curved portion, a facemask passage 704, a releasable fastener passage 728, and a base passage. The releasable securing mechanism 701 desirably includes a flange cap 710, a driving surface 712, a fastener 714, a core pin 718, ball bearings or solid bodies 720, a magnetic component 722, 726, and a base 724.

The securing mechanism 701 can include the base 724 which secures the mask clip 104 to the helmet 100. The base 7244 includes a generally cylindrical body 220 and a flange. A portion of the cylindrical body is inserted into the base passage of the mask clip 700 while the remaining portion of the cylindrical body passes through an opening of the helmet 100. The opening of the helmet 100 is desirably dimensioned such that the flange does not pass through the opening. The flange desirably abuts an inner surface of the helmet 100. In some embodiments, to attach the mask clip 700 to the helmet 100, the cylindrical body of the base 724 may be passed through the opening of the helmet 100 until the flange abuts the inner surface of the helmet 100; the mask clip 700 may then be press fit onto the portion of the cylindrical body that protrudes from the outer surface of the helmet 100 until the lower portion abuts the outer surface of the helmet 100. The base 724 desirably receives and retains a portion of the fastener 714 and thereby prevents the removal of the fastener 714 upon insertion, which is discussed in greater detail with regards to FIGS. 2-7.

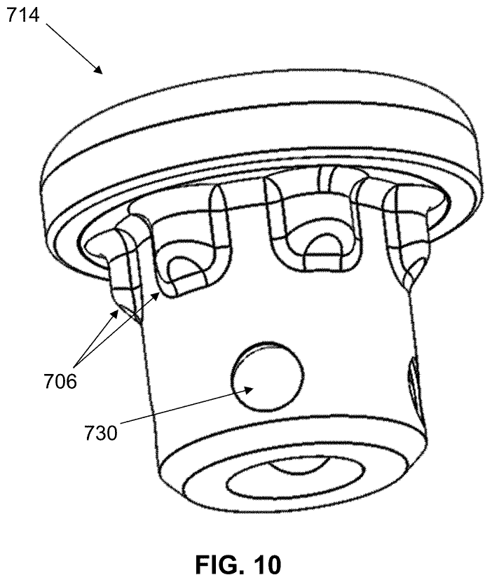

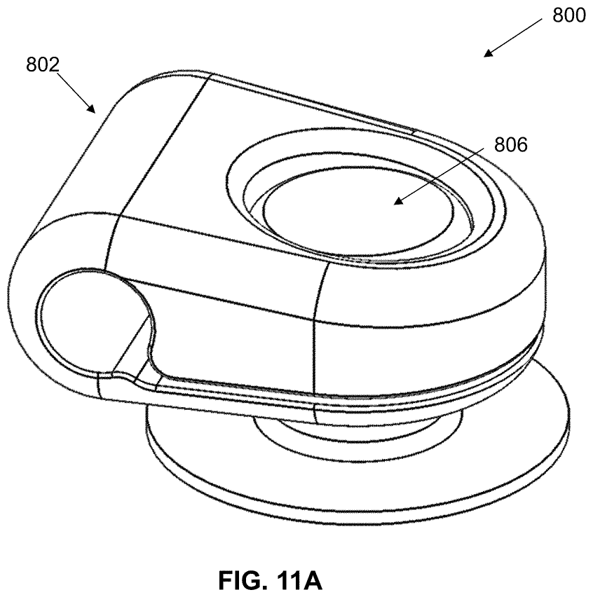

The securing mechanism 200 further includes the fastener 714 as shown in FIG. 10. The fastener 714 is insertable into the fastener passage 728 of the upper portion of the clip 702. As previously mentioned, a portion of the fastener 714 is inserted into the base 724, which is discussed in greater detail with regards to FIGS. 2-7. Once inserted into the base 724, the fastener 714 desirably secures the mask clip 700 in the closed state, thereby securing the facemask 102 enclosed within the mask clip 700 to the helmet 100.

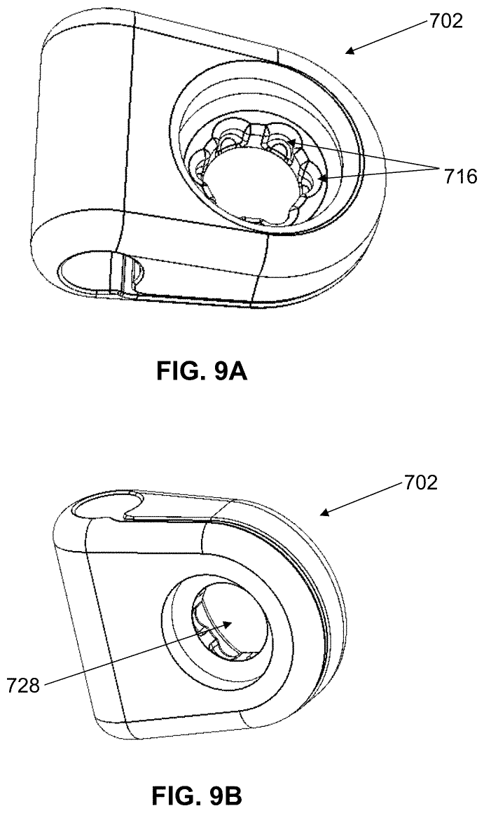

The mask clip 700 comprises a clip 702, and a securing mechanism 701, constructed in accordance with various teachings of the present invention, with FIG. 8C depicting an exploded view thereof. In this embodiment, the flange cap 710 of the securing mechanism 701 incorporates a “flathead” driving surface 712, although various other driving arrangements (i.e., Phillips, oval, triangular, square drive, hex wrench, hexalobular or Torx drive, etc.) could be employed with varying utility. As best seen in FIGS. 9A and 9B, the corresponding fastener 714 in this embodiment can desirably include a series of depressions 716, which can engage with and contain corresponding protrusions 706 on the fastener 714 (see FIG. 10). The fastener 714 may further include a plurality of openings or recesses 730, the plurality of openings or recesses 730 may be disposed on the surface of the fastener 714, either symmetrically or asymmetrically around the circumference or perimeter of the fastener 714. The plurality of openings or recesses 730 are sized and configured to receive a portion of the solid bodies or ball bearings 720.

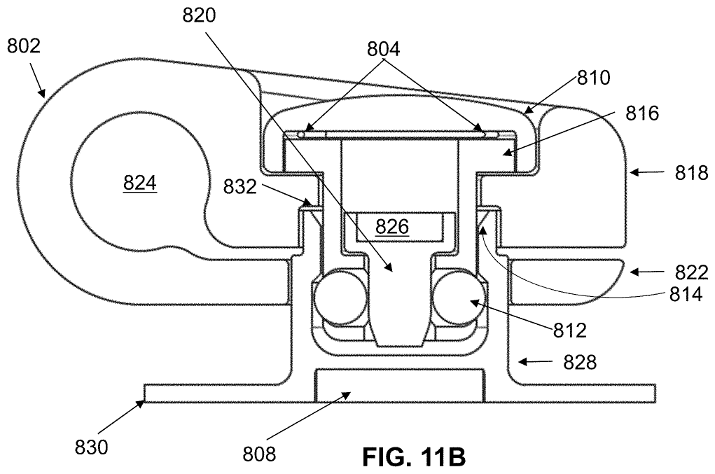

FIG. 11A depicts a perspective view of another alternative embodiment of a mask clip 800. The mask clip 800 comprises a clip 802 and a releasable securing mechanism 806 constructed in accordance with various teachings of the present invention, with FIG. 11B depicting a cross-sectional view of the assembly thereof. The clip 802 includes a lower portion 822, an upper portion 818, a curved portion, a facemask passage 824, a releasable fastener passage 814, a base passage and a ledge 832. At least one surface of the ledge 832 mates with at least one surface of the fastener 816. The releasable securing mechanism 806 desirably includes a flange cap 810, a wire 804, a fastener 816, a core pin 820, ball bearings or solid bodies 812, a magnetic component 808, 826, and a base 828.

In this embodiment, the mask clip 800 incorporates a generally curved or smooth flange cap 810 which desirably does not incorporate a supplemental driving feature. In addition, the fastener passage 814 of the clip 802 can be formed in an uninterrupted, generally cylindrical shape, without necessarily incorporating the depressions and/or splines of previous embodiments in the clip 802 and mask clip 800. Desirably, the flange cap 810 can be press-fit and/or peened into place on the mask clip 800, with the fastener 816 optionally capable of rotating within the passage 814, if desired. If desired, a variety of shapes other than cylindrical for the fastener and/or fastener passage could be utilized (i.e., oval, triangular, square, hexagonal, etc.) could be employed in alternative embodiments.

In this embodiment, the mask clip 800 further incorporates a wire 804 (i.e., steel wire) or other ferrous/magnetic component in an upper portion of the mask clip 800, which desirably will attract the core pin 820 towards the upper portions of the fastener 816, thereby biasing the fastener 816 to an unlocked state when the device is unassembled (thereby allowing the fastener 816 to be freely inserted or otherwise manipulated). However, when the fastener 816 is placed into the flange 830, the proximity of a lower magnetic component 808 in the flange base desirably attracts the core pin 820 in a downward direction to a greater degree than the wire tends to draw it upward, thereby biasing the fastener to a locked state when assembled (and desirably preventing the fastener from being inadvertently removed or dislodged from the flange 830). If subsequent removal of the fastener is desired, a separate magnetic tool (not shown) can be placed near the fastener, as previously described, to desirably overcome the downward magnetic attraction of the lower magnetic component 810 and impel the core pin 820 in an upward direction (through magnetic attraction and/or repulsion, as desired) to unlock the fastener for removal.

In various embodiments, it may be desirous to seal or otherwise isolate the various internal components and/or component assemblies described herein from fluids, dirt and/or foreign debris, including debris that could lead to corrosion of the various ferrous and/or magnetic components of the disclosed system. In such a case, an epoxy or other coating/material could be incorporated into the various components herein to provide such isolation. For example, the opening in the lower portion of the fastener may be sealed using a flexible epoxy or other material, if desired. In other embodiments, various components including magnetic and/or ferrous components could be titanium coated or otherwise treated to reduce corrosion, fretting and/or improve component wear.

The various embodiments of securing mechanism, including those described with regards to FIGS. 1-7, FIGS. 8 through 10 and FIGS. 11A and 11B might be used for several other applications that require a mechanism that can be quickly and conveniently assembled and released. For example, the securing mechanism may be used in place of standardized mechanical hardware in sporting goods, automotive applications, industrial applications, aerospace applications, medical device applications, or any other suitable application.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

### INCORPORATION BY REFERENCE/EQUIVALENTS

The entire disclosure of each of the publications, patent documents, and other references referred to herein is incorporated herein by reference in its entirety for all purposes to the same extent as if each individual source were individually denoted as being incorporated by reference.

The invention may be embodied in other specific forms without departing from the spirit or essential characteristics thereof. The foregoing embodiments are therefore to be considered in all respects illustrative rather than limiting on the invention described herein. Scope of the invention is thus intended to include all changes that come within the meaning and range of equivalency of the descriptions provided herein.

Many of the aspects and advantages of the present invention may be more clearly understood and appreciated by reference to the accompanying drawings. The accompanying drawings are incorporated herein and form a part of the specification, illustrating embodiments of the present invention and together with the description, disclose the principles of the invention.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the disclosure herein. What have been described above are examples of the present invention. It is, of course, not possible to describe every conceivable combination of components or methodologies for purposes of describing the present invention, but one of ordinary skill in the art should recognize that many further combinations and permutations of the present invention are possible. Accordingly, the present invention is intended to embrace all such alterations, modifications and variations that fall within the spirit and scope of the appended claims, including various combinations of the individual features from the individual embodiments disclosed herein.

What is claimed is:

1. A securing mechanism comprising:
a fastener comprising a generally cylindrical body having a passage and a plurality of side openings, with a first magnetic component positioned near a proximal end of the cylindrical body;
a core pin inserted into the passage of the fastener and movable within the passage between an unlocked position and a locked position, the core pin comprising a second magnetic component, with the second magnetic component attracted towards the first magnetic component with a first level of attraction force that draws the core pin towards the proximal end of the cylindrical body;
a base formed with a securing passage and comprising:
an opening through which a distal end of the cylindrical body is inserted into the securing passage, the opening including a reduced diameter portion protruding inwards from an inner surface of the securing passage, and
a third magnetic component positioned at a distal end of the base, the third magnetic component attracting the core pin towards the distal end of the cylindrical body with a second level of attraction force that is greater than the first level of attraction force; and
a plurality of solid bodies within the cylindrical body, each of the solid bodies protruding outwards towards the inner surface of the securing passage via a respective side opening responsive to the core pin moving into the locked position, the engagement of the inner ring and the protruding solid bodies preventing separation of the fastener from the base.

2. The securing mechanism of claim 1, wherein the plurality of solid bodies can freely move inwards into the cylindrical body when the fastener is in the unlocked state.

3. The securing mechanism of claim 1, wherein an instrument comprising a fourth magnetic component pulls the core pin into the unlocked state by attracting the second magnetic component of the core pin to facilitate the removal of the fastener from the base.

4. The securing mechanism of claim 1, wherein a flange cap is removeably secured to the cylindrical body via a threaded interface, the flange cap further comprising a driving surface for engaging a tool that rotates the flange cap relative to the cylindrical body of the fastener.

5. The securing mechanism of claim 4, wherein removal of the flange cap from the body of the fastener allows the core pin to be extracted from the fastener to allow removal of the fastener from the base.

6. The securing mechanism of claim 1, wherein the securing mechanism secures a first object to a second object.

7. The securing mechanism of claim 6, wherein the first object is a football helmet, and the second object is a clip for a facemask of a football helmet.

8. A securing mechanism comprising:
a fastener, the fastener comprises an internal passage and a plurality of openings;
a core pin, the core pin movable within the internal passage of the fastener between an unlocked state and a locked state, the core pin comprising a first magnetic component;
a base, the base comprising an interior surface defining a securing passage dimensioned to receive a portion of the fastener, the base comprising a second magnetic component pulling the core pin towards the locked state by attracting the first magnetic component; and
a plurality of solid bodies, at least a portion of the plurality of solid bodies disposed within a portion of the plurality of openings, the plurality of solid bodies pushed by the core pin towards the interior surface of the base from the plurality of openings of the fastener to prevent separation of the fastener from the base responsive to the core pin moving into the locked state.

9. The securing mechanism of claim 8, wherein each solid body of the plurality of solid bodies is spherical.

10. The securing mechanism of claim 8, wherein the securing passage of the base comprises an inner ring configured to engage the plurality of solid bodies in the locked state.

11. The securing mechanism of claim 8, wherein the fastener further comprises a third magnetic component that pulls the core pin towards the unlocked state by attracting the first magnetic component.

12. The securing mechanism of claim 11, wherein the unlocked state is the default state of the fastener when the fastener is not inserted into the base.

13. The securing mechanism of claim 8, wherein an instrument comprising a third magnetic component pulls the core pin into the unlocked state by attracting the first magnetic component of the core pin.

14. The securing mechanism of claim 13, wherein the instrument facilitates the removal of the fastener from the base.

15. The securing mechanism of claim 8, wherein the fastener further comprises a flange cap that is removeably secured to a proximal end of the fastener.

16. The securing mechanism of claim 8, wherein the base further comprises a flange, the flange extending perpendicularly away from at least a portion of the base.

17. The securing mechanism of claim 15, wherein the flange cap comprises a driving surface for engaging a tool that rotates the flange cap relative to a body of the fastener.

18. The securing mechanism of claim 15, wherein the flange cap is removed from the body of the fastener such that the core pin is extracted from the fastener and the fastener is removed from the base.

19. The securing mechanism of claim 8, wherein the securing mechanism further comprises an inner ring.

20. The securing mechanism of claim 8, wherein the interior surface of the base further comprises a plurality of recesses, the plurality of recesses align with the plurality of openings of the fastener.
